(19) United States
(12) Patent Application Publication
(10) Pub. No.: US 2015/0370739 A1
(43) Pub. Date: Dec. 24, 2015

(54) LOCAL RECONNECTION ATTEMPTS FOR SERIAL ATTACHED SMALL COMPUTER SYSTEM INTERFACE EXPANDERS

(71) Applicant: LSI Corporation, San Jose, CA (US)

(72) Inventors: William K. Petty, Colorado Springs, CO (US); Gregory A. Johnson, Colorado Springs, CO (US)

(21) Appl. No.: 14/312,581

(22) Filed: Jun. 23, 2014

(51) Int. Cl. G06F 13/40; G06F 13/42

(52) U.S. Cl. CPC G06F 13/4022; G06F 13/4282; G06F 13/4068; G06F 2213/4004; G06F 2213/3604

(57) ABSTRACT

Methods and structure for local reconnect attempts via a Serial Attached Small Computer System Interface (SAS) expander. The system includes a SAS expander, which includes a physical link (PHY) that is able to transmit an OPEN Address Frame (OAF) to a coupled SAS device, and to receive an OPEN_REJECT (RETRY) from the coupled device in response to the OAF. The SAS expander also includes a controller that is able to block transmission of the OPEN_REJECT (RETRY) out of the expander in order to preserve a signaling pathway established for the OAF, and to retransmit the OAF to the coupled device via the PHY.

### FIELD OF THE INVENTION

The invention relates generally to Small Computer System Interface (SCSI) systems, and more specifically to Serial Attached SCSI (SAS) systems.

### BACKGROUND

In deeply cascaded SAS topologies, it can take substantial amounts of time to establish a connection between a target and initiator. The larger the number of intervening expanders that are placed between the target and initiator, the larger the number of links that have to be occupied in order to establish a pathway for the connection. This in turn means a longer delay between initially requesting the connection at the target and actually establishing the connection at the initiator. If an initiator is presently unable to service a connection for a target, it sends an OPEN_REJECT (RETRY) primitive to the target, causing intervening expanders to tear down the pathway that has been established for the connection. When the target retries the rejected connection request, it takes time to re-establish the pathway to the initiator. During the time that the pathway to the initiator is being re-established for the connection request, the initiator might start servicing a connection request from a different target.

### SUMMARY

Systems and methods herein provide for SAS expanders that block the transmission of OPEN REJECT (RETRY) primitives sent by a SAS end device, and resend the rejected OAF to the SAS end device in order to locally retry establishing a connection. One exemplary embodiment is a system that includes a SAS expander. The SAS expander includes a physical link (PHY) that is able to transmit an OPEN Address Frame (OAF) to a coupled SAS device, and to receive an OPEN_REJECT (RETRY) from the coupled device in response to the OAF. The SAS expander also includes a controller that is able to block transmission of the OPEN_REJECT (RETRY) out of the expander in order to preserve a signaling pathway established for the OAF, and to retransmit the rejected OAF to the coupled device via the PHY.

Other exemplary embodiments (e.g., methods and computer readable media relating to the foregoing embodiments) are also described below.

### BRIEF DESCRIPTION OF THE FIGURES

Some embodiments of the present invention are now described, by way of example only, and with reference to the accompanying figures. The same reference number represents the same element or the same type of element on all figures.

FIG. 1 is a block diagram of an exemplary SAS domain.

FIG. 2 is a flowchart describing an exemplary method to locally retry a connection at a SAS expander.

FIGS. 3-4 are block diagrams illustrating exemplary communications between PHYs of a SAS expander.

FIG. 5 is a block diagram illustrating an exemplary PHY of a SAS expander.

FIGS. 6-7 are tables illustrating exemplary retry counts for a SAS expander.

FIGS. 8-9 are message diagrams illustrating exemplary communications within a SAS domain.

FIGS. 10-12 are flowcharts illustrating further exemplary methods to locally retry a connection at a SAS expander.

FIG. 13 illustrates an exemplary processing system operable to execute programmed instructions embodied on a computer readable medium.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

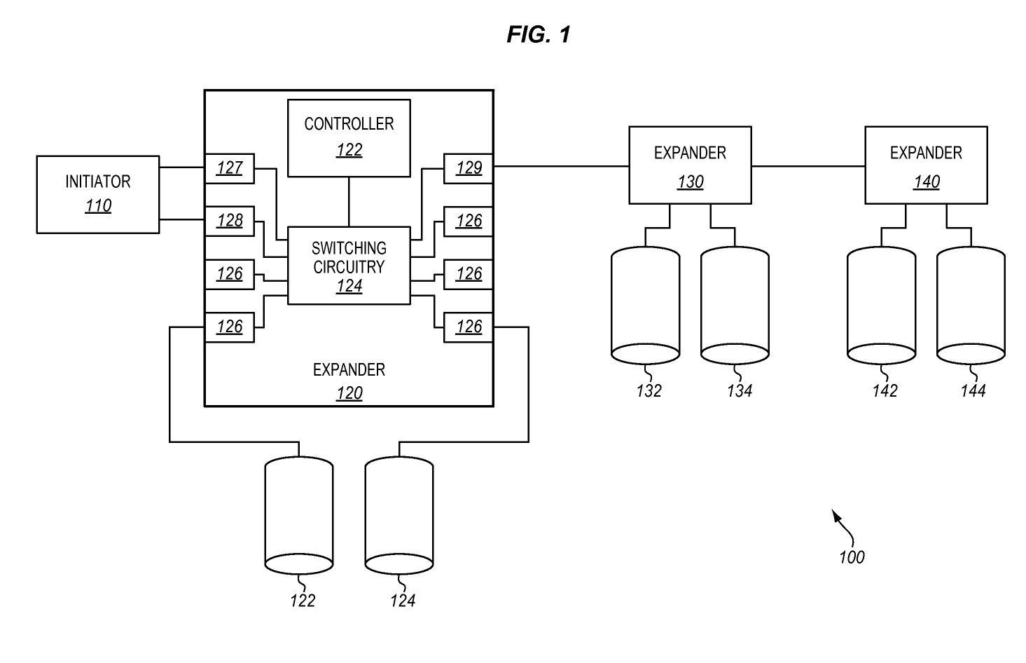

FIG. 1 is a block diagram of an exemplary SAS domain 100. SAS domain 100 establishes connections between an initiator and one or more targets in order to enable Input/Output (I/O) operations between them. In this embodiment, SAS domain 100 includes SAS initiator 110, which is coupled via expanders 120, 130, and 140 to targets 122, 124, 132, 134, 142, and 144. As used herein, initiators and targets are collectively referred to as end devices. SAS domain 100 is a cascaded topology, because individual SAS/Serial Advanced Technology Attachment (SATA) targets are separated from initiator 110 by a potentially large number of intervening SAS expanders.

During normal operations, connections are established between initiator 110 and the targets in order to transfer data (e.g., on behalf of a host system). After a connection has been closed (e.g., after initiator 110 sends and receives a CLOSE primitive sequence), initiator 110 appears to be available for servicing another connection. However, initiator 110 could still be emptying data out of a receive buffer of a physical link (PHY), or could otherwise be temporarily delayed (e.g., by other operations related to the connection that just closed). This means that even though the connection is closed and initiator 110 appears to be available, initiator 110 is not actually available to service incoming connection requests, such as OPEN Address Frames (OAFs). Initiator 110 could therefore potentially respond to an OAF with an OPEN_REJECT (RETRY) primitive.

In general, an OPEN_REJECT (*) causes the pathway used for an OAF to be torn down. However, an OPEN_REJECT (RETRY) creates a problem in a cascaded SAS domain having a large number of expanders between the initiator and the target. Specifically, in order to re-send the rejected OAF, each expander in the pathway re-arbitrates and re-establishes its own portion of the pathway, and each of these individual arbitration/setup delays stacks additively with the others.

In order to prevent the substantial arbitration and setup delays resulting from OPEN_REJECT (RETRY) messages in deeply cascaded topologies, SAS expander 120 is capable of blocking the transmission of an OPEN_REJECT (RETRY) to other devices until the rejected OAF has been locally re-sent a number of times. This temporarily prevents the pathway for the OAF from being torn down. If initiator 110 becomes available during one of the retries of the OAF, an OPEN_ACCEPT is sent by initiator 110 instead of an OPEN_REJECT (RETRY), establishing the connection. Thus, OAFs can be locally resent by expander 120 without the need to tear down and re-establish any pathways established for those OAFs.

SAS initiator 110 comprises any suitable device or component that is compliant with SAS protocols such as Serial SCSI Protocol (SSP), SATA Tunneled Protocol (STP), Serial Management Protocol (SMP), etc. For example, in one embodiment SAS initiator 110 comprises a Host Bus Adapter (HBA) that utilizes SSP to exchange host I/O with other end devices. In order to establish a connection with a target, initiator 110 utilizes a SAS port comprising one or more PHYs. In this embodiment, initiator 110 utilizes a wide port made up of two PHYs (127 and 128).

SAS expanders 120, 130, and 140 comprise any suitable devices capable of establishing connections between PHYs of end devices in accordance with SAS protocols. Specifically, each expander includes multiple internal PHYs that can be electrically coupled with each other via switching circuitry (e.g., a crossbar switch) in order to route connections to different SAS devices. When multiple expanders are located between the end devices of a connection, each expander operates its switching circuitry to establish a portion of the pathway for the connection.

SAS expander 120 comprises controller 122, switching circuitry 124, and PHYs 126-129. Controller 122 manages the operations of expander 120, and can be implemented for example as custom circuitry, a processor executing programmed instructions stored in program memory, or some combination thereof. For example, controller 122 can comprise an Expander Connection Manager (ECM) (as shown in FIG. 1), can comprise link layer circuitry components of one or more PHYs 126-129, etc. Switching circuitry 124 comprises any suitable components operable to electrically connect pairs of PHYs together. For example, switching circuitry 124 can comprise an Expander Connection Router (ECR) implemented by a crossbar switch, etc. PHYs 126-129 comprise physical links capable of implementing SAS standards.

While three expanders are shown in FIG. 1, any number of expanders or similar routing elements can be combined to form a “switched fabric” of interconnected elements between initiators and targets in SAS domain 100. Targets 122, 124, 132, 134, 142, and 144 receive communications from the expanders of FIG. 1, and comprise any suitable SAS and/or SATA compliant devices, such as storage devices (e.g., disk drives, etc.). The particular arrangement, number, and configuration of components described herein with regard to FIG. 1 is exemplary and non-limiting.

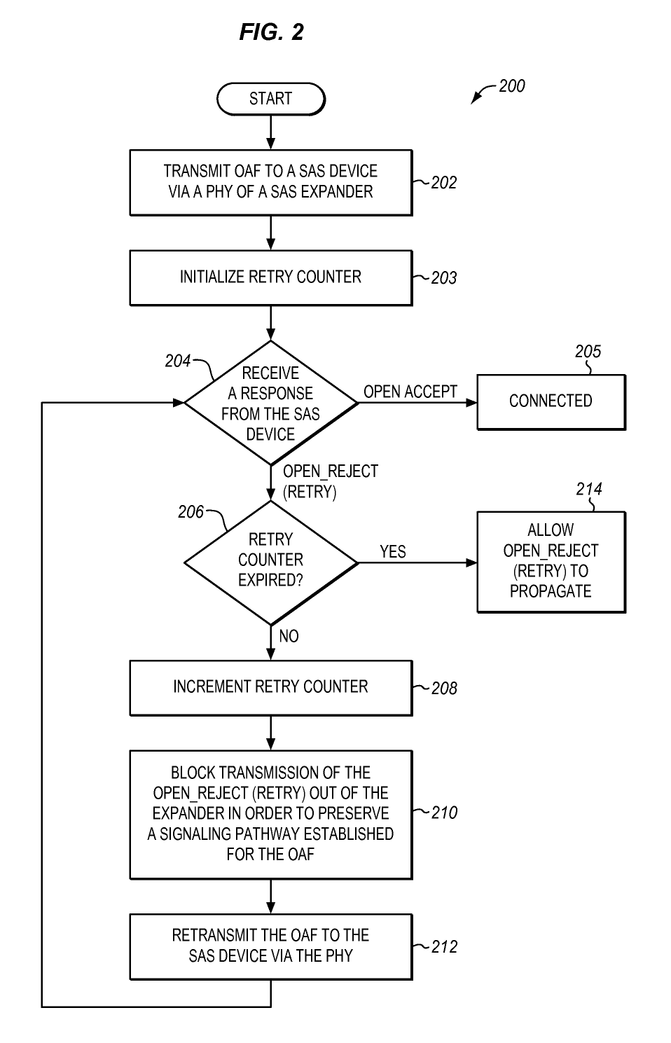

FIG. 2 is a flowchart describing an exemplary method 200 to locally retry a connection at a SAS expander. Although PHY 127 is discussed with regard to method 200, PHY 128 can be used to perform similar operations as described for PHY 127. Assume, for this embodiment, that initiator 110 has just closed a connection with target 122 through PHY 127 by transmitting and receiving a CLOSE primitive sequence, but has not yet had time to completely clear out buffered receive data for the connection. Thus, initiator 110 is not presently able to service incoming OAFs received via expander 120 through PHY 127. However, initiator 110 appears to be available through PHY 127, because the most recent connection at initiator 110 through PHY 127 has been closed. Thus, expander 120 decides that an OAF from target 144 can be sent to initiator 110 through PHY 127.

According to method 200, in step 202, PHY 129 transmits the OAF via PHY 127 to a PHY of initiator 110. Expander 120 then waits to determine whether the connection has been accepted at initiator 110, and controller 122 (e.g., via link layer logic of PHY 129) in step 203 initializes a retry counter indicating the number of times that the connection has been locally retried (at this point in time, the retry counter is set to zero).

Initiator 110 responds in step 204 by sending either an OPEN ACCEPT (terminating the process and forming a connection, as indicated by step 205) or by sending OPEN_REJECT (RETRY) primitive, which is received at PHY 127. Instead of transmitting an OPEN_REJECT (RETRY) back to the target device that originated the OAF (which would tear down the signaling pathway established for the OAF), controller 122 checks whether the retry counter has expired in step 206.

If the retry counter has expired/reached its limit, then in step 214 controller 122 allows the OPEN_REJECT (RETRY) to propagate to downstream devices and tear down the signaling pathway. However, if the retry counter has not expired/reached its limit in step 206, controller 122 increments the retry counter in step 208, and blocks transmission of the OPEN_REJECT (RETRY) out of expander 120 in step 210. This preserves the remaining signaling pathway previously established for the OAF between PHY 129 and storage device 144, because it prevents the other expanders from receiving the OPEN_REJECT (RETRY) and performing tear down processes. Controller 122 directs PHY 129, which stores the OAF, to re-arbitrate for a connection to initiator 110, and then re-send the OAF. PHY 129 then retransmits the OAF to initiator 110 (i.e., via either PHY 127 or PHY 128 based on the result of the arbitration process in expander 120) in step 212.

If initiator 110 is no longer busy, it replies with an OPEN_ACCEPT, thereby establishing the requested connection and completing the method. Alternatively, if initiator 110 is still busy, it replies with another OPEN_REJECT (RETRY). This new OPEN_REJECT (RETRY) can be blocked again and replied to with another OAF by proceeding to step 204 and continuing the method. Alternatively, if enough retries of the OAF have already been sent, controller 122 can stop blocking the OPEN_REJECT (RETRY) and allow it to be forwarded to other devices (e.g., as in step 214), tearing down the pathway that would have been used for the requested connection.

In a further embodiment, initiator 110 can itself transmit its own OAF via PHY 127 to expander 120 immediately after sending an OPEN_REJECT (RETRY), if a connection is desired. In this case, the retry from PHY 129 might not yet have an available path through expander 120 to initiator 110, but will keep on arbitrating for one, ensuring that the pathway through the other SAS devices is maintained.

While some references are made to PHY 127, PHY 128 can perform similar operations with regard to communicating with initiator 110. For example, retry attempts can use any physical links of the wide port to complete the requested connection (e.g., based on which physical links are currently available).

Method 200 mediates the undesirable delays found in cascaded topologies. Specifically, by sending out multiple “retry” OAFs, expander 120 gives initiator 110 enough time to empty out its receive buffer and accept a connection. If emptying a receive buffer is preventing initiator 110 from servicing a connection, initiator 110 will eventually become available (e.g., after about 100 nanoseconds to about one microsecond) and allow an incoming OAF to be serviced. This prevents the substantial delays that would otherwise be caused by tearing down and re-establishing a deeply cascaded connection (e.g., between about ten microseconds and about one hundred milliseconds).

Even though the steps of method 200 are described with reference to expander 120 of FIG. 1, method 200 can be performed with respect to other devices (e.g., the method can be performed by other expanders, can be performed for OAFs sent to/from all kinds of end devices, etc.). The steps of the flowcharts described herein are not all inclusive and can include other steps not shown. The steps described herein can also be performed in an alternative order. Furthermore, while a single physical link has been discussed for the initial connection attempt of method 200, the retry attempts can use different physical links to complete the connection, based on which physical links are currently available.

In a further embodiment, in order to prevent congestion at SAS domain 100, expander 120 only blocks an OPEN_REJECT (RETRY) if the OPEN_REJECT (RETRY) was received from a directly attached end device (e.g., as indicated by a received IDENTIFY address frame (IAF), DEVICE TYPE field=001b (End device), or a routing attribute for a PHY at expander 120). This ensures that only one expander in each pathway attempts the multiple retry technique whenever a connection is requested.

### EXAMPLES

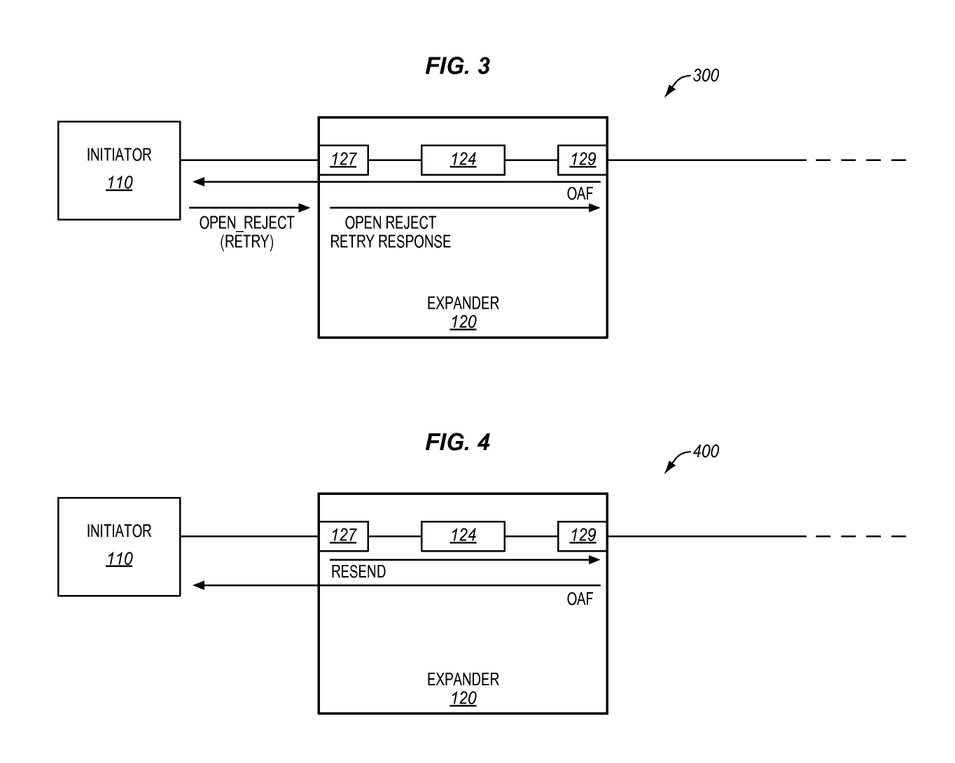

In the following examples, additional processes, systems, and methods are described with respect to local connection retry attempts for SAS expanders. FIGS. 3-4 are block diagrams 300-400 illustrating communications between PHYs of a SAS expander. According to these block diagrams, controller 122 of FIG. 1 is implemented as link layer logic inside of PHYs 127-128 and PHY 129 (e.g., as hardware circuitry implementing one or more SAS XL state machines for one or more PHYs).

FIGS. 3-4 include block diagrams 300 and 400, which illustrate an embodiment where PHY 127 (or PHY 128) operates as a pass-through entity to provide an OAF from PHY 129 to initiator 110, and then after PHY 127 (or PHY 128) receives an OPEN_REJECT (RETRY) primitive from initiator 110, PHY 127 (or PHY 128) passes an Open Reject Retry response to PHY 129. Thus, in this embodiment, the OPEN_REJECT (RETRY) primitive that is received by PHY 127 (or PHY 128) from initiator 110 does not pass as a primitive through switching circuitry 124 (e.g., an ECR). Instead of sending the OPEN_REJECT (RETRY) in its original form, PHY 127 (or PHY 128) sends an Open Reject Retry response to switching circuitry 124. Then, PHY 129 receives the Open Reject Retry response as a confirmation from switching circuitry 124.

In this example, upon detecting the OPEN_REJECT (RETRY) primitive, PHY 127 (or PHY 128), which knows that it is directly attached to the end device that sent the OPEN_REJECT (RETRY) (e.g., based on a received IDENTIFY address frame (IAF), DEVICE TYPE field=001b (End device), or a routing attribute in a routing table) determines a number of retries for the OAF, preserves the pathway established for the OAF locally in expander 120, and sends a resend signal to PHY 129. The number of retries indicates how many times PHY 129 will re-send an OAF before allowing the OPEN_REJECT (RETRY) primitive to be forwarded out of expander 120 through PHY 129. The number of retries can vary, for example, based on a number of intervening expanders between the end devices for the requested connection, based on the Arbitration Wait Time (AWT) indicated in the OAF, or any other suitable metric. If the connection is not established after the last retry, PHY 127 (or PHY 128) releases pathway resources and sends an Open Reject Retry response without a resend signal to switching circuitry 124. After PHY 129 receives the Open Reject Retry response as a confirmation without a resend signal from switching circuitry 124, PHY 129 can transmit an OPEN_REJECT (RETRY) primitive to other devices after releasing any pathway resources.

The number of retries can be a fixed or varying value, and the number can be stored in a programmable register, a hardware device table or routing table maintained in a solid state memory, or any other suitable components. For example, Link layer hardware/circuitry can set a number of retries defined by a combination of flip-flops and gates (e.g., as described by a hardware description language (HDL) such as Verilog RTL (register-transfer level)). The flip-flops and gates can implement a retry equation such as n=a+b*(AWT)+c*(AWT)̂2, where the constants a, b, and c are determined by programmable registers, AWT is the arbitration wait time of the OAF, and n is the number of retries. Another exemplary setting equation is n=a+b*(numExp)+c*(numExp)̂2 where constants a, b, and c are determined by programmable registers, and numExp is a routing attribute received from an ECM table that indicates the number of expanders located between the coupled device and the end device that sourced the OPEN Address Frame.

The Open Reject Retry response signal sent by PHY 127 (or PHY 128) can comprise a customized and/or vendor-specific SAS primitive, can comprise the original OPEN_REJECT (RETRY) primitive with corresponding sideband signaling sent via switching circuitry 124, or can comprise sideband signaling sent via switching circuitry 124. In response to receiving the Open Reject Retry response signal and the resend signal from PHY 127 (or PHY 128), a link layer component of PHY 129 preserves the pathway established for the OAF locally in expander 120, and prevents the transmission of the OPEN_REJECT (RETRY) to downstream devices, which preserves the pathway established for the OAF in the downstream expanders and an end device. Then, PHY 129 resends the OAF to initiator 110 via PHY 127 (or PHY 128).

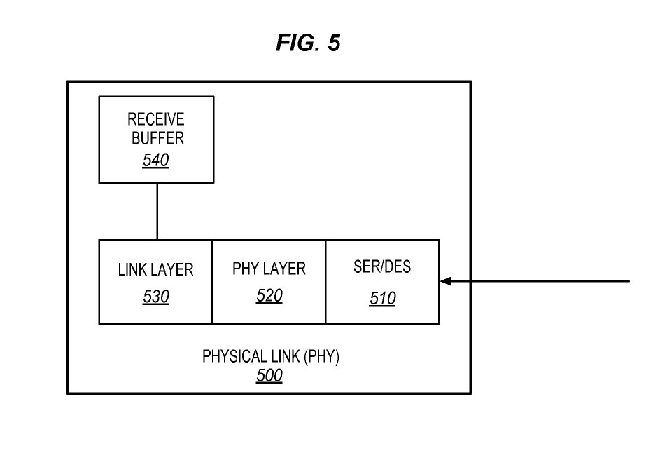

FIG. 5 is a block diagram illustrating an exemplary PHYSICAL LINK (PHY) 500 of a SAS expander. According to FIG. 5, PHYSICAL LINK (PHY) 500 includes a serializer/deserializer (Ser/Des) 510, a PHY layer 520 that operates to arrange received data in the appropriate order, a receive buffer 540 (e.g. to store a received OAF), and a link layer 530. These elements of PHYSICAL LINK (PHY) 500 include both receive and transmit paths for transferring data. A controller is implemented within link layer 530 of PHYSICAL LINK (PHY) 500, and serves to manage the overall operations of PHYSICAL LINK (PHY) 500.

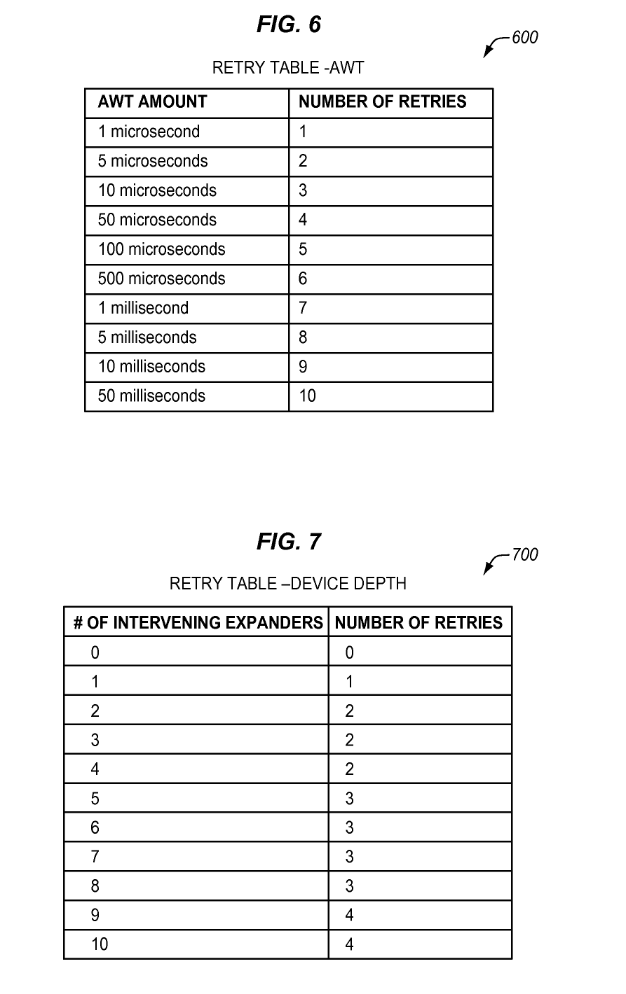

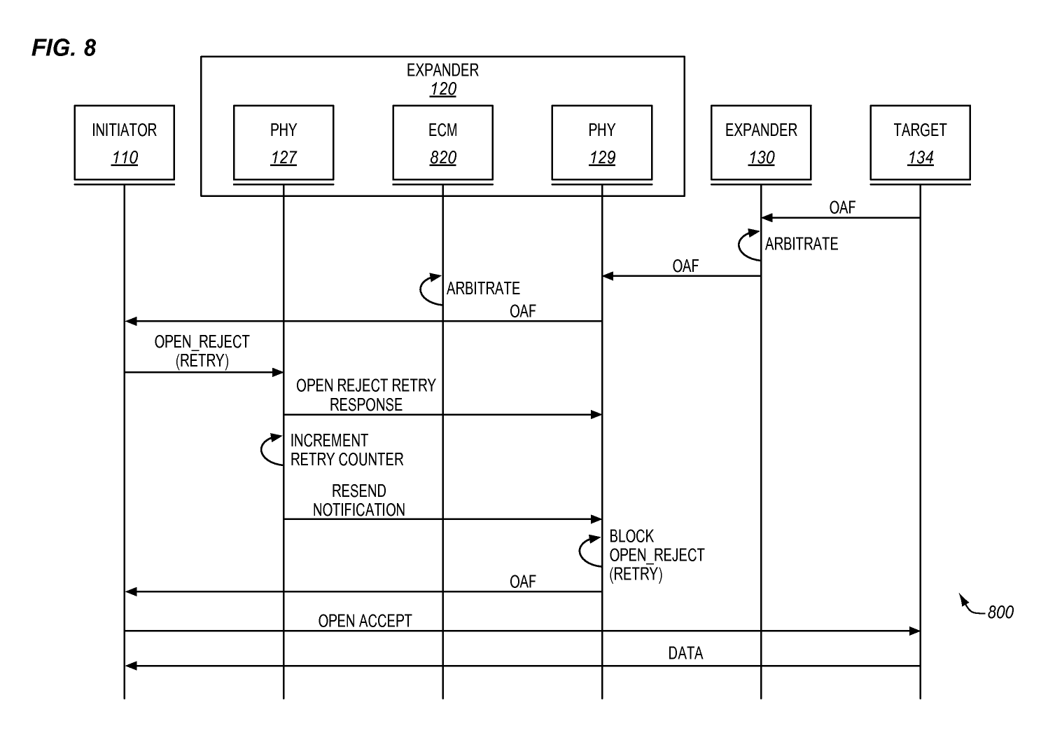

FIGS. 6-7 are tables illustrating exemplary retry counts for a SAS expander. Specifically, table 600 of FIG. 6 indicates a number of retries to perform based on the AWT of an OAF, while table 700 of FIG. 7 indicates a number of retries to perform based on device depth in the SAS topology (i.e., the number of SAS expanders between the end devices indicated in the OAF). In one embodiment, table 700 is integrated into a hardware device table or routing table of the SAS expander.

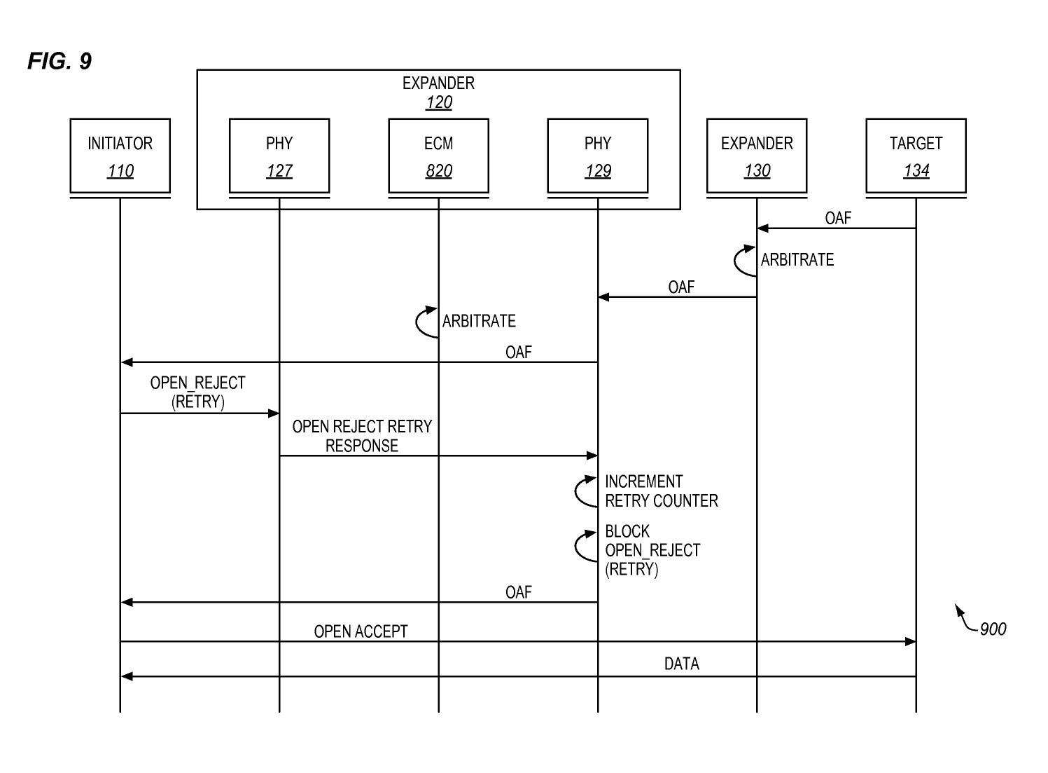

FIGS. 8-9 are message diagrams illustrating exemplary communications within a SAS domain. According to message diagram 800 of FIG. 8, target 134 attempts to establish a connection in order to transfer data to initiator 110. Target 134 starts the process by sending an OAF to expander 130, to which it is directly connected. Expander 130 receives the OAF, and identifies an internal PHY to route the OAF through, based on a destination address indicated in the OAF. Expander 130 then engages in arbitration to determine whether the OAF sent by target 134 should be serviced. In this example, the OAF wins the arbitration process against competing OAFs from other targets and/or expanders. Therefore, expander 130 adjusts its switching circuitry to establish an electrical link/connection between a PHY that received the OAF and a PHY that is coupled with expander 120.

The OAF is then forwarded onwards to PHY 129 of expander 120, and expander 120 engages in its own arbitration process at ECM 820. The OAF wins arbitration, and expander 120 adjusts its switching circuitry (e.g., via an ECR that receives input from ECM 820) to establish an electrical link/connection between PHY 129 (which received the OAF) and PHY 127 (which is coupled with initiator 110). At this point, the OAF is transmitted to initiator 110. Since initiator 110 is currently busy, it responds by sending an OPEN_REJECT (RETRY). The OPEN_REJECT (RETRY) primitive is then indicated to PHY 129 via PHY 127. In this example, PHY 127 sends an Open Reject Retry response signal, such as a customized and/or vendor-specific SAS primitive, the original OPEN_REJECT (RETRY) primitive with corresponding sideband signaling, or sideband signaling, etc. to PHY 129. Before sending the Open Reject Retry response signal into the switching circuitry 124, a link layer of PHY 127 checks a retry counter stored in a programmable register and determines that the OAF should be resent. PHY 127 therefore also sends a resend notification to PHY 129, causing PHY 129 to block transmission of the OPEN_REJECT (RETRY) out of expander 120 and to resend the OAF through PHY 127. By this time, initiator 110 has become available, and responds to the OAF with an OPEN_ACCEPT, establishing the connection. The OPEN_ACCEPT is forwarded to target 134, which sends out data to initiator 110.

FIG. 9 is a message diagram 900 illustrating exemplary communications within a SAS domain. According to FIG. 9, target 134 attempts to establish a connection in order to transfer data to initiator 110. Target 134 starts the process by sending an OAF to expander 130, to which it is directly connected. Expander 130 receives the OAF, and identifies an internal PHY to route the OAF through, based on a destination address indicated in the OAF. Expander 130 then engages in arbitration to determine whether the OAF sent by target 134 should be serviced. In this example, the OAF wins the arbitration process against competing OAFs from other targets and/or expanders. Therefore, expander 130 adjusts its switching circuitry to establish an electrical link/connection between a PHY that received the OAF and a PHY that is coupled with expander 120.

The OAF is then forwarded onwards to PHY 129 of expander 120, and expander 120 engages in its own arbitration process at ECM 820. The OAF wins arbitration, and expander 120 adjusts its switching circuitry (e.g., via an ECR that receives input from ECM 820) to establish an electrical link/connection between PHY 129 (which received the OAF) and PHY 127 (which is coupled with initiator 110). At this point, the OAF is transmitted to initiator 110. Since initiator 110 is currently busy, it responds by sending an OPEN_REJECT (RETRY). The OPEN_REJECT (RETRY) primitive is then indicated to PHY 129 via PHY 127. In this example, PHY 127 sends an Open Reject Retry response signal, such as a customized and/or vendor-specific SAS primitive, the original OPEN_REJECT (RETRY) primitive with corresponding sideband signaling, or sideband signaling, etc. to PHY 129. Upon receiving the Open Reject Retry response signal as a confirmation from switching circuitry 124, a link layer of PHY 129 checks a retry counter stored in a programmable register and determines that PHY 129 should block transmission of the OPEN_REJECT (RETRY) out of expander 120 and that the OAF should be resent. PHY 129 therefore re-arbitrates for a connection to initiator 110 and resends the OAF through either PHY 127 or another phy based on the result of the arbitration process in expander 120. By this time, initiator 110 has become available, and responds to the OAF with an OPEN_ACCEPT, establishing the connection. The OPEN_ACCEPT is forwarded to target 134, which sends out data to initiator 110.

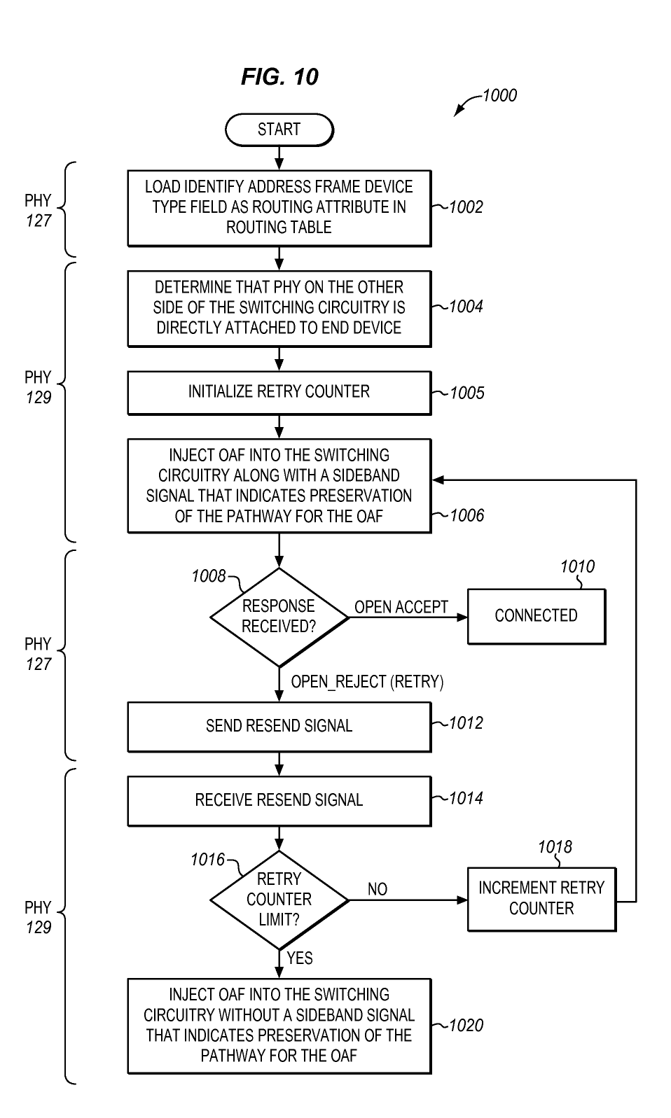

FIGS. 10-12 are flowcharts illustrating further exemplary methods to locally retry a connection at a SAS expander. Specifically, these methods describe how a received OPEN_REJECT (RETRY) is managed at a SAS expander. Assume, for method 1000, that an IDENTIFY address frame has been exchanged between PHY 127 and a PHY of initiator 110. The received IDENTIFY address frame includes a DEVICE TYPE field=001b (End device) that is loaded as a routing attribute into a routing table (e.g. located in an ECM portion of controller 122) in step 1002. An OAF directed to initiator 110 is then received at PHY 129. The controller 122 and switching circuitry 124 of the expander (e.g., an ECM and an ECR, respectively) then electrically connect PHY 129 and PHY 127. PHY 129 acquires the stored routing attribute, determines in step 1004 based on the routing attribute that the PHY on the other side of the ECR/crossbar (i.e. PHY 127) is directly attached to an end device, and then initializes a retry counter in step 1005.

Because PHY 127 is directly attached to an end device, when PHY 129 first injects a received OAF into switching circuitry 124 (e.g., the ECR), it also inserts a sideband signal (e.g. “PreservePathResources=1”) for PHY 127 in step 1006. The sideband signal tells PHY 127, after PHY 127 forwards the OAF to the initiator 110, to continue to preserve the pathway established for the OAF locally in expander 120 if an OPEN_REJECT (RETRY) is received from the initiator 110. If PHY 127 receives an OPEN ACCEPT in step 1008, then a connection is formed in step 1010 and the method ends.

However, if PHY 127 receives an OPEN_REJECT (RETRY) from initiator 110 in step 1008, then since PreservePathResources=1, PHY 127 sends a “resend signal” in step 1012 and an Open Reject Retry response as described above to PHY 129. PHY 129 maintains a retry counter. When PHY 129 receives the resend signal from PHY 127 in step 1014, PHY 129 checks a retry counter in step 1016 to ensure that the retry counter limit has not yet been reached. If the retry counter limit has not been reached, PHY 129 preserves the pathway established for the OAF locally in expander 120, and prevents the transmission of the OPEN_REJECT (RETRY) which preserves the pathway established for the OAF in the downstream expanders and an end device. Then in step 1018 PHY 129 increments the retry counter and proceeds to step 1006, resending the OAF via switching circuitry 124 toward PHY 127 and therefore initiator 110.

However, if in step 1016 the retry counter has already reached its limit, then PHY 129 injects the OAF into the crossbar with a sideband signal stating “PreservePathResources=0” (i.e., the OAF is sent without sideband signaling asking for pathway resources to be preserved after an OPEN_REJECT (RETRY) is received) in step 1020. When PreservePathResources=0, PHY 127 will not send another resend signal to PHY 129, and any received OPEN_REJECT (RETRY) from initiator 110 leads to the tear down of the connection back to the downstream end device that initially tried to establish the connection. PHY 127 and 129 therefore cooperate in order to continue to preserve the pathway established for the OAF locally in expander 120 if an OPEN_REJECT (RETRY) is received from initiator 110. For example, PHY 127 can access information in a received IDENTIFY address frame to determine that PHY 127 is directly attached to an end device (e.g. if the DEVICE TYPE field=001b (End device)), and PHY 129 can manage the counting of retries and the local resending of OAFs.

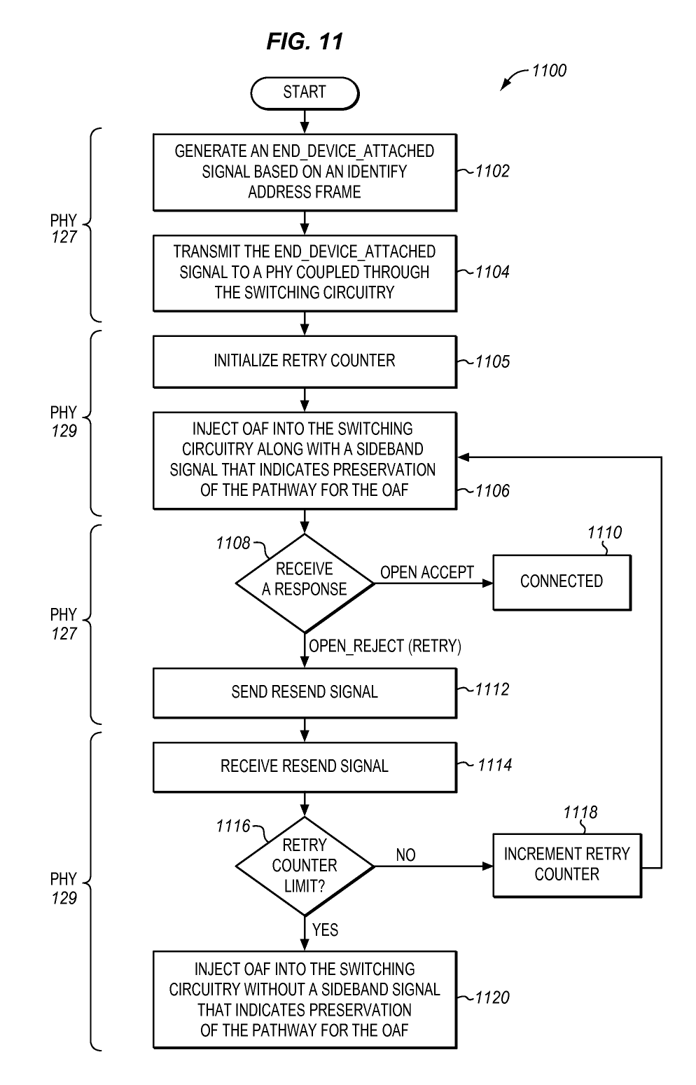

Assume, for method 1100 of FIG. 11, that IDENTIFY address frames have been exchanged between PHY 127 and a PHY of initiator 110. In step 1102, PHY 127 generates an EndDeviceAttached signal based on the received IDENTIFY address frame (e.g. “EndDeviceAttached=1” if the DEVICE TYPE field is set to 001b (End device)). In the process of the ECM/ECR connecting PHY 129 and PHY 127, PHY 127 passes its EndDeviceAttached signal as a sideband signal to PHY 129 in step 1104. Since PHY 127 is directly attached to an end device as indicated by the EndDeviceAttached signal, PHY 129 initializes a retry counter in step 1105, and PHY 129 injects a received OAF into switching circuitry 124 (e.g., the ECR) with a sideband signal (e.g. “PreservePathResources=1”) for PHY 127 in step 1106. The sideband signal tells PHY 127, after PHY 127 forwards the OAF to the initiator 110, to continue to preserve the pathway established for the OAF locally in expander 120 if an OPEN_REJECT (RETRY) is received from the initiator 110. PHY 127 then receives a response from initiator 110 in step 1108, in the form of an OPEN ACCEPT (which forms a connection as in step 1110), or in the form of an OPEN_REJECT (RETRY).

If the response is an OPEN_REJECT (RETRY), then since PreservePathResources=1, PHY 127 sends a “resend signal” in step 1112 and an Open Reject Retry response as described above to PHY 129. When PHY 129 receives the resend signal from PHY 127 in step 1114, PHY 129 checks a retry counter in step 1116 to ensure that the retry counter limit has not yet been reached. If the retry counter limit has not been reached, PHY 129 preserves the pathway established for the OAF locally in expander 120, and prevents the transmission of the OPEN_REJECT (RETRY) which preserves the pathway established for the OAF in the downstream expanders and an end device. Then in step 1118 PHY 129 increments the retry counter and proceeds to step 1106, resending the OAF via switching circuitry 124 toward PHY 127 and therefore initiator 110.

However, if in step 1116 the retry counter has already reached its limit, then PHY 129 injects the OAF into the crossbar with a sideband signal stating “PreservePathResources=0” (i.e., the OAF is sent without sideband signaling asking for pathway resources to be preserved after an OPEN_REJECT (RETRY) is received) in step 1120. When PreservePathResources=0, PHY 127 will not send another resend signal to PHY 129, and any received OPEN_REJECT (RETRY) from initiator 110 leads to the tear down of the connection back to the downstream end device that initially tried to establish the connection. PHY 127 and 129 therefore cooperate in order to continue to preserve the pathway established for the OAF locally in expander 120 if an OPEN_REJECT (RETRY) is received from initiator 110. For example, PHY 127 can access information in a received IDENTIFY address frame to determine that PHY 127 is directly attached to an end device (e.g. if the DEVICE TYPE field=001b (End device)), and PHY 129 can manage the counting of retries and the local resending of OAFs. PHY 127 is discussed instead of PHYs 127-128 in order to preserve the clarity of the above methods. However, PHY 128 can perform similar operations to PHY 127.

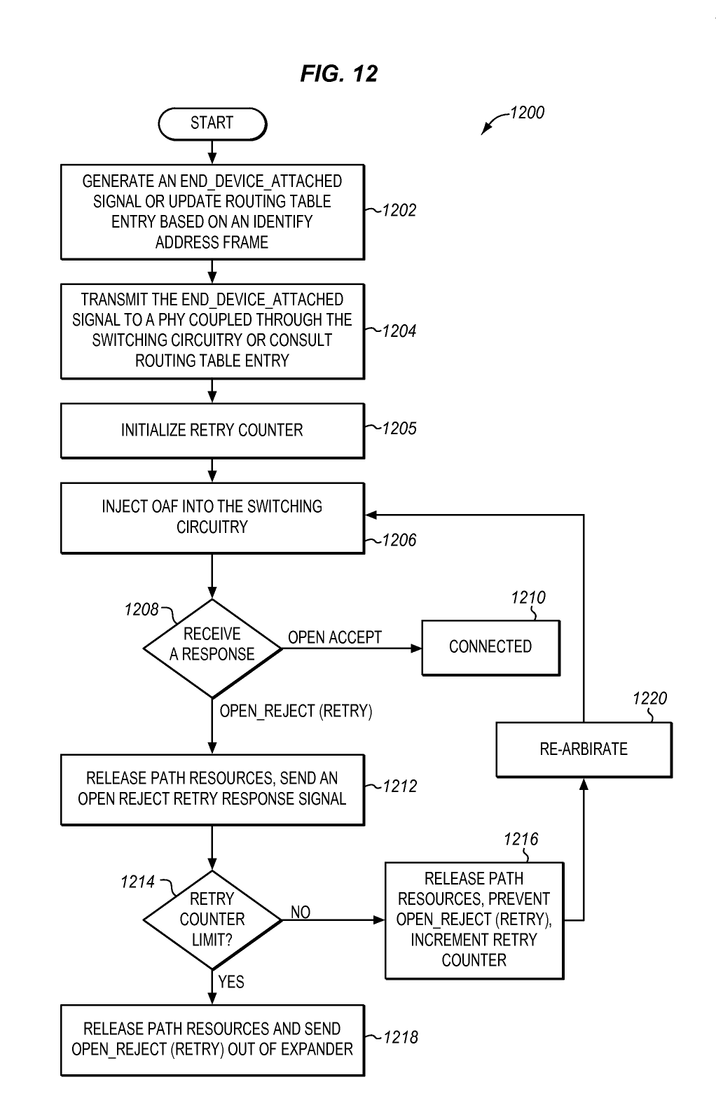

FIG. 12 illustrates a still further method 1200. According to method 1200, PHYs 127-128 have information in received IDENTIFY address frame(s) indicating that PHY 127 and PHY 128 are directly attached to an end device (i.e. if the DEVICE TYPE field=001b (End device)). After IDENTIFY address frame exchanges between PHY 127 and initiator 110, and PHY 128 and initiator 110, the information in the received IDENTIFY address frames can be used in PHY 127 and PHY 128 to create an EndDeviceAttached sideband signal in step 1202. Alternatively, step 1202 can comprise updating a routing table entry based on the IDENTIFY address frames. In the process of an ECM/ECR connecting PHY 129 with PHY 127 (or PHY 128), PHY 127 (or PHY 128) in step 1204 passes its EndDeviceAttached signal as a sideband signal to PHY 129, or PHY 129 uses a corresponding routing table attribute. Since PHY 127 (or PHY 128) is directly attached to an end device as indicated by the EndDeviceAttached signal, PHY 129 initializes a retry counter in step 1205. Then, PHY 129 sends the OAF to initiator 110 via PHY 127 (or PHY 128) in step 1206.

PHY 127 (or PHY 128) then receives a response from initiator 110 in step 1208 in the form of an OPEN ACCEPT (thereby forming a connection in step 1210), or in the form of an OPEN_REJECT (RETRY). If PHY 127 (or PHY 128) receives an OPEN_REJECT (RETRY) from initiator 110, then PHY 127 (or PHY 128) releases any pathway resources and then sends the “Open Reject Retry response signal” described above to PHY 129 in step 1212. PHY 129 maintains the retry counter and uses the EndDeviceAttached signal, or a corresponding routing table attribute. If the retry counter has not reached its limit in step 1214, then when PHY 129 receives the “Open Reject Retry response signal” from PHY 127 (or PHY 128), PHY 129 releases any pathway resources (i.e. the pathway established for the OAF locally in expander 120), prevents the transmission of the OPEN_REJECT (RETRY) which preserves the pathway established for the OAF in the downstream expanders and an end device, and increments the retry counter in step 1216. Then, PHY 129 re-arbitrates for a connection to the initiator 110 in step 1220 and resends the OAF into the crossbar in step 1206 to either PHY 127 or PHY 128 (based on the result of the arbitration process in expander 120) and on to initiator 110. However, if the retry counter has reached its limit, PHY 129 releases any pathway resources, and sends OPEN_REJECT (RETRY) out of the expander in step 1218, which will lead to the tear down of the connection back to an end device (e.g., end device 144).

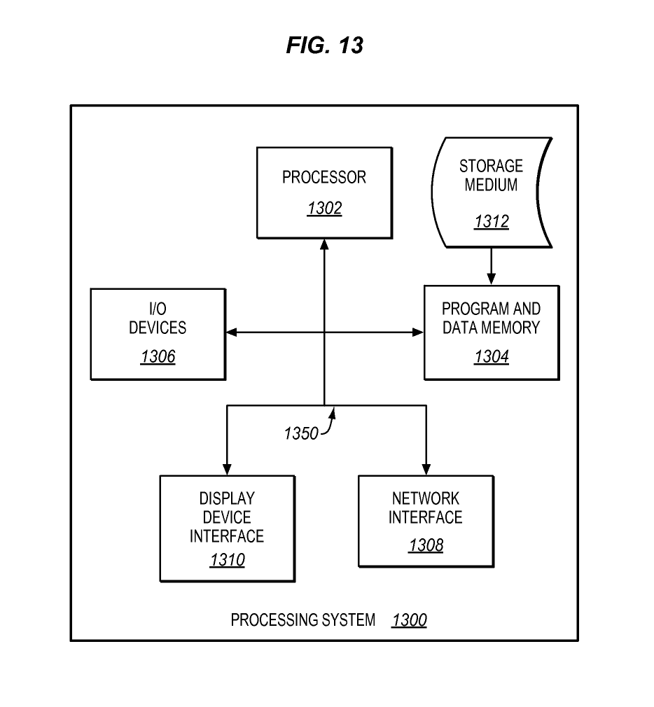

Embodiments disclosed herein can take the form of software, hardware, firmware, or various combinations thereof In one particular embodiment, software is used to direct a processing system of a SAS expander to perform the various operations disclosed herein. FIG. 13 illustrates an exemplary processing system 1300 operable to execute a computer readable medium embodying programmed instructions. Processing system 1300 is operable to perform the above operations by executing programmed instructions tangibly embodied on computer readable storage medium 1312. In this regard, embodiments of the invention can take the form of a computer program accessible via computer readable medium 1312 providing program code for use by a computer (e.g., processing system 1300) or any other instruction execution system. For the purposes of this description, computer readable storage medium 1312 can be anything that can contain or store the program for use by the computer (e.g., processing system 1300).

Computer readable storage medium 1312 can be an electronic, magnetic, optical, electromagnetic, infrared, or semiconductor device. Examples of computer readable storage medium 1312 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and digital video disk (DVD).

Processing system 1300, being suitable for storing and/or executing the program code, includes at least one processor 1302 coupled to program and data memory 1304 through a system bus 1350. Program and data memory 1304 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 1306 (including but not limited to keyboards, displays, pointing devices, etc.) can be coupled either directly or through intervening I/O controllers. Network adapter interfaces 1308 can also be integrated with the system to enable processing system 1300 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 1310 can be integrated with the system to interface to one or more display devices, such as printing systems and screens for presentation of data generated by processor 1302.

What is claimed is:

1. A system comprising:
a Serial Attached Small Computer System Interface expander, comprising:
a physical link operable to transmit an OPEN Address Frame to a coupled Serial Attached Small Computer System Interface device, and to receive an OPEN_REJECT (RETRY) from the coupled device in response to the OPEN Address Frame; and
a controller operable to block transmission of the OPEN_REJECT (RETRY) out of the expander in order to preserve a signaling pathway established for the OPEN Address Frame, and to retransmit the OPEN Address Frame to the coupled device via the physical link.

2. The system of claim 1, wherein:
the coupled device comprises an end device, and
the controller is further operable to block transmission of the OPEN_REJECT (RETRY) in response to determining that the physical link is directly attached to the end device.

3. The system of claim 1, wherein:
blocking transmission of the OPEN_REJECT (RETRY) comprises preventing a physical link of the expander from transmitting the OPEN_REJECT (RETRY) to another device along the signaling pathway.

4. The system of claim 1, wherein:
the controller is further operable to retransmit the OPEN Address Frame a number of times based on an Arbitration Wait Time of the OPEN Address Frame.

5. The system of claim 1, wherein:
the controller is further operable to review the OPEN Address Frame to identify an end device that sourced the OPEN Address Frame, and to retransmit the OPEN Address Frame a number of times based on a number of expanders located between the coupled device and the end device that sourced the OPEN Address Frame.

6. The system of claim 1, wherein the expander comprises:
multiple physical links, including the physical link; and
an Expander Connection Router operable to establish electrical connections between the multiple physical links; and
the controller comprises an Expander Connection Manager.

7. The system of claim 1, wherein:
the controller comprises:
link layer circuitry for the physical link, operable to receive the OPEN_REJECT (RETRY) from the coupled device; and
link layer circuitry for a second physical link, operable to block transmission of the OPEN_REJECT (RETRY) outside of the expander, and to resend the OPEN Address Frame to the physical link.

8. A method comprising:
transmitting an OPEN Address Frame to a coupled Serial Attached Small Computer System Interface device, via a physical link of a Serial Attached Small Computer System Interface expander;
receiving, at the physical link, an OPEN_REJECT (RETRY) from the coupled device in response to the OPEN Address Frame;
blocking transmission of the OPEN_REJECT (RETRY) out of the expander in order to preserve a signaling pathway established for the OPEN Address Frame; and
retransmitting the OPEN Address Frame to the coupled device via the physical link.

9. The method of claim 8, wherein:
the coupled device comprises an end device, and the method further comprises:
blocking transmission of the OPEN_REJECT (RETRY) in response to determining that the physical link is directly attached to the end device.

10. The method of claim 8, wherein:
blocking transmission of the OPEN_REJECT (RETRY) comprises preventing a physical link of the expander from transmitting the OPEN_REJECT (RETRY) to another device along the signaling pathway.

11. The method of claim 8, further comprising:
retransmitting the OPEN Address Frame a number of times based on an Arbitration Wait Time of the OPEN Address Frame.

12. The method of claim 8, further comprising:
reviewing the OPEN Address Frame to identify an end device that sourced the OPEN Address Frame; and
retransmitting the OPEN Address Frame a number of times based on a number of expanders located between the coupled device and the end device that sourced the OPEN Address Frame.

13. The method of claim 8, wherein the expander comprises:
multiple physical links, including the physical link, and the method further comprises
operating an Expander Connection Router, based on input from an Expander Connection Manager, to establish electrical connections between the multiple physical links.

14. The method of claim 8, further comprising:
receiving the OPEN_REJECT (RETRY) from the coupled device, via link layer circuitry for the physical link; and
blocking transmission of the OPEN_REJECT (RETRY) outside of the expander, and resending the OPEN Address Frame to the physical link, via link layer circuitry for a second physical link.

15. A system comprising:
a Serial Attached Small Computer System Interface expander, comprising:
a means for transmitting an OPEN Address Frame to a coupled Serial Attached Small Computer System Interface device, and for receiving an OPEN_REJECT (RETRY) from the coupled device in response to the OPEN Address Frame; and
a means for blocking transmission of the OPEN_REJECT (RETRY) out of the expander in order to preserve a signaling pathway established for the OPEN Address Frame, and retransmitting the OPEN Address Frame to the coupled device via the physical link.

16. The system of claim 15, wherein:
the coupled device comprises an end device, and
the means for blocking is further for blocking transmission of the OPEN_REJECT (RETRY) in response to determining that the physical link is directly attached to the end device.

17. The system of claim 15, wherein:
blocking transmission of the OPEN_REJECT (RETRY) comprises preventing a physical link of the expander from transmitting the OPEN_REJECT (RETRY) to another device along the signaling pathway.

18. The system of claim 15, wherein:
the means for blocking is further for retransmitting the OPEN Address Frame a number of times based on an Arbitration Wait Time of the OPEN Address Frame.

19. The system of claim 15, wherein:
the means for blocking is further for reviewing the OPEN Address Frame to identify an end device that sourced the OPEN Address Frame, and for retransmitting the OPEN Address Frame a number of times based on a number of expanders located between the coupled device and the end device that sourced the OPEN Address Frame.

20. The system of claim 15, wherein:
the means for transmitting comprises one of multiple physical links of the expander;
the means for blocking comprises an Expander Connection Manager of the expander; and
the expander further comprises an Expander Connection Router operable to establish electrical connections between the multiple physical links.
